(19) United States
(12) Patent Application Publication
(10) Pub. No.: US 2016/0356892 A1
(43) Pub. Date: Dec. 8, 2016

(54) PRESSURE ALTITUDE STABILIZATION

(71) Applicant: Sandel Avionics, Inc., Vista, CA (US)

(72) Inventors: Gerald J. Block, Vista, CA (US); William J. Warkany, Vista, CA (US)

(21) Appl. No.: 15/142,744

(22) Filed: Apr. 29, 2016

Related U.S. Application Data
(63) Continuation of application No. 13/746,003, filed on Jan. 21, 2013, now abandoned.
(60) Provisional application No. 61/588,781, filed on Jan. 20, 2012.

(51) Int. Cl. G01S 19/41; G01C 5/00

(52) U.S. Cl. CPC G01S 19/41; G01C 5/005

(57) ABSTRACT

A method and apparatus is provided for determining the altitude of an aircraft. In accordance with the method, Global Positioning Satellite (GPS) data is received from a plurality of GPS satellites and a GPS altitude value is determined from the GPS data. In addition, a pressure altitude value is determined. An altitude difference is determined between the GPS altitude value and the pressure altitude value. At least one of the GPS altitude value and the pressure altitude value is adjusted using the altitude difference.

### CROSS-REFERENCE TO RELATED APPLICATION

This application is a continuation of U.S. patent application Ser. No. 13/746,003, filed Jan. 21, 2013, entitled “PRESSURE ALTITUDE STABILIZATION”, which claims the benefit of U.S. Provisional Application Ser. No. 61/588,781, filed Jan. 20, 2012 owned by the assignee of the present application and hereby incorporated by reference in their entireties.

### BACKGROUND

Avionics applications often use an airborne barometric or pressure altimeter to provide altitude information. The pressure altimeter is able to estimate altitude above mean sea level based on comparing measured barometric pressure to a standard atmosphere value.

However, one problem with altitude measurement technique is that even if a barometric altimeter accurately measures barometric pressure and converts the pressure reading to a corresponding altitude, such conversion merely provides an altitude value from a pressure/altitude chart or table representing standard atmosphere data. A problem in using such charts is that an aircraft does not fly in a standard atmosphere, but in the real atmosphere which is subject to temporal and spatial weather differences affecting the barometric pressure measured at any aircraft altitude. As a result, since there will virtually always be a discrepancy between the actual pressure as measured at the aircraft location and the standard pressure for the aircraft elevation, there will virtually always be a discrepancy in a barometric altimeter reading. Aircraft flight crews therefore need to be continuously supplied with altimeter calibration information and data correlating pressure altitude with geometric height. In many cases this information needs to be provided every few minutes.

Altitude information may also be obtained from a Global Positioning Satellite (GPS) system. The altitude information obtained in this way is absolute and does not require calibration. However, the quality of the GPS data is subject to significant variability, particularly when an aircraft undergoes a rapid change in orientation. This problem can be particularly acute for aircraft such as helicopters, which typically fly at much lower altitudes and in much closer proximity to the underlying terrain and other obstacles than other aircraft and would therefore appear to have at least as great, if not greater, of a need for an accurate altitude measurements.

Accordingly, neither pressure altimeters nor GPS systems are fully satisfactory instruments for obtaining altitude information.

### SUMMARY

In accordance with the present invention, a method and apparatus is provided for determining the altitude of an aircraft. In accordance with the method, GPS data is received from a plurality of GPS satellites and a GPS altitude value is determined from the GPS data. In addition, a pressure altitude value is determined. An altitude difference is determined between the GPS altitude value and the pressure altitude value. At least one of the GPS altitude value and the pressure altitude value is adjusted using the altitude difference.

In accordance with another aspect of the invention, the pressure altitude value is adjusted by adding the altitude difference thereto.

In accordance with yet another aspect of the invention, if a rate of change in the GPS altitude value that is determined exceeds a threshold value, a corrected altitude value is determined by summing the pressure altitude value and the altitude difference.

In accordance with another aspect of the invention, the altitude difference is filtered to obtain a moving average altitude difference, wherein adjusting at least one of the GPS altitude value and the pressure altitude value comprises adjusting at least one of the GPS altitude value and the pressure altitude value using the moving average altitude difference.

In accordance with another aspect of the invention, the altitude difference is filtered using an IIR filter or a single-pole filter.

In accordance with another aspect of the invention, the IIR filter has a prescribed time-constant which increases with time from startup.

In accordance with another aspect of the invention, the increase in the prescribed time-constant terminates after a given amount of time (e.g., between about 15 and 30 minutes).

In accordance with another aspect of the invention, the GPS altitude value is filtered to remove noise therein.

In accordance with another aspect of the invention, a figure of merit associated with GPS data is received and a corrected altitude is determined by summing the pressure altitude value and the altitude difference when the figure of merit falls below a prescribed value.

In accordance with another aspect of the invention, an apparatus is provided for determining an altitude of an aircraft. The apparatus includes a GPS receiver, a pressure altimeter and processor. The GPS receiver receives GPS data from a plurality of GPS satellites and determines a GPS altitude value from the GPS data. The pressure altimeter determines a pressure altitude value. The processor is configured to determine an altitude difference between the GPS altitude value and the pressure altitude value. The processor is also configured to adjust at least one of the GPS altitude value and the pressure altitude value using the altitude difference.

### BRIEF DESCRIPTION OF THE DRAWINGS

FIG. 1 is a block diagram depicting one embodiment of an apparatus for determining the altitude of an aircraft.

FIG. 2 is an alternative block diagram representation of the apparatus shown in FIG. 1.

FIG. 3 is a flowchart illustrating one example of method for determining altitude.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

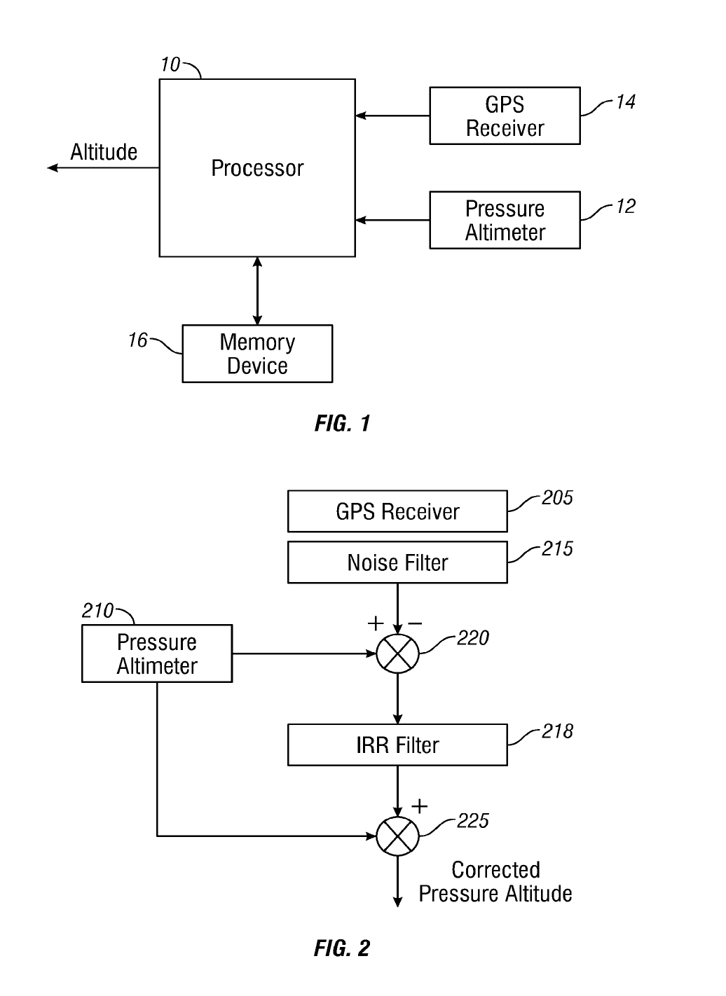

Referring now to FIG. 1, a block diagram depicting an apparatus for determining the altitude of an aircraft according to one embodiment of the present invention. As generally illustrated, the apparatus includes a processor 10 for communicating with a pressure altimeter 12 and a Global Positioning Satellite (GPS) receiver 14. Both instruments can be used to measure altitude values. The processor 10 can then provide altitude values based on a combination of the values obtained from the pressure altimeter 12 and GPS receiver 14. The output values from the processor 10 can be provided to an avionics subsystem such as a ground proximity warning system, for example.

Typically, the processor 10 is a data processing device, such as a microprocessor, a microcontroller or other central processing unit. However, the processor can be embodied in another logic device such as a DMA (direct memory access) processor, an integrated communication processor device, a custom VLSI (very large scale integration) device, or an ASIC (application specific integrated circuit) device. Moreover, the processor can be any other type of analog or digital circuitry or any combination of hardware and software that is designed to perform the processing functions described hereinbelow. A memory device 16 may be associated with the processor 10. The memory device 16 may include RAM, ROM and/or a mass storage medium such as a magnetic or optical storage medium.

The pressure altimeter 12 employs well-known measurement techniques for measuring altitude. Such pressure altimeters are actually pressure gauges that are calibrated in units of distance relative to the known pressure at the surface of the earth. As previously mentioned, the atmosphere is subject to temporal and spatial weather differences affecting the barometric pressure measured at any aircraft altitude. Accordingly, one disadvantage of a pressure altimeter is that it requires periodic calibration because the pressure at the surface of the earth changes constantly. In some cases the calibration may need to be performed every few minutes, particularly when an aircraft is traversing large lateral areas of land.

When not calibrated, the pressure altitude reading is termed uncorrected barometric altitude. When calibrated, it is termed corrected barometric altitude.

While pressure altitude measurements do not provide absolute altitude measurements unless they are calibrated, pressure altitude differentials are generally correct even they are uncalibrated. In other words, readings taken 1000 feet apart in altitude will generally show a 1000 foot difference in pressure altitude, no matter the calibration of the pressure altimeter.

The GPS receiver 14 receives signals from orbiting satellites that are used as references. The receivers measure the time it takes for the signals to reach the receiver. After receiving the signals from three or more GPS satellites, the receiver can triangulate its position relative to the Earth's surface. GPS altimeter measurements provide an absolute value for altitude and do not need to undergo calibration.

Although the details depend on the particular GPS system that is employed, the GPS receiver 14 will typically provide signals indicative of the GPS altitude as well as signals indicative of the latitude and longitude of the aircraft, the ground speed of the aircraft, the ground track angle of the aircraft (also known as the true track angle of the aircraft) and an indication of the quality of the data provided by the GPS receiver. The quality of the data determines the uncertainty in the altitude data that is provided by the GPS receiver. Data quality may vary for a variety of reasons, including, for instance, the number of satellites that are being tracked at any given time by the GPS receiver.

Due in part to the speed of aircraft and the degrees of freedom of motion available to them, the number of GPS satellites that is being tracked may fluctuate, sometimes in a very rapid manner. For instance, a simple bank turn, particular in the case of a helicopter, may cause a number of satellites to go out of view or come into view. As a result the uncertainty in the GPS altitude data may also fluctuate significantly. Thus, the GPS altitude data may suddenly become unreliable or unstable, and this problem may occur when the aircraft is undergoing a particularly sensitive maneuver.

GPS altitude data could be used as the primary or sole source of altitude data if the problems noted above did not occur. That is, GPS altitude data is generally reliable unless it indicates any rapid changes in altitude, at which time the data becomes suspect. This problem can be addressed by supplementing the GPS altitude data with pressure altitude data when the GPS altitude data is suspect. In other words, pressure altitude data can be used as a supplement to, a correction to, or instead of, the GPS altitude data when the GPS data indicates rapid altitude changes beyond some threshold value. In this way rapid changes in the measured altitude due to artifacts such as changes in the number of satellites being tracked will not be treated as actual changes in the altitude of the aircraft.

As previously noted, changes in altitude determined from pressure altitude data are correct even without calibration. Accordingly, the pressure altitude data that is used when the altitude obtained from the GPS receiver indicates large, rapid changes in altitude may be uncalibrated pressure altitude data.

The precise manner in which the pressure altitude data may be used in conjunction with the GPS altitude data may vary from implementation to implementation. In general a wide variety of different approaches may used. One illustrative technique will be presented below.

In this example the value of the altitude obtained from the GPS receiver will be referred to as AG. The data obtained from GPS receiver may be filtered to remove noise. For purposes of illustration AG will be used to refer to the altitude regardless of whether the data has been filtered in this manner. Likewise, the uncorrected value of the pressure altitude obtained from the pressure altimeter will be referred to as Apressure_uncorrected or Apu. In this example a difference is calculated:

D=Apu's−AG,

Where D is termed the current altitude offset or difference. In order to remove short-term fluctuations in the current altitude offset and expose the longer-term trend, the current altitude offset may be filtered with a low pass filter. For instance, an IIR filter or single-pole filter may be employed. In some implementations the weight of the filter may change over time. That is, the filter may have a prescribed time-constant that increases with time from startup (e.g., from the time the aircraft takes off). The increase in the prescribed time-constant terminates after a given amount of time, which may be the amount of time it takes for the aircraft's altitude to stabilize after takeoff. For instance, in some embodiments the time-constant may increase for a period of about 30 minutes or in other cases for a period of about 15 minutes.

The filtered value of the altitude offset D may be added to AG to result in a final value of altitude that is very accurate and stable when the GPS data becomes unreliable, e.g., when the aircraft undergoes sudden banks or turns or the like. This corrected value of the pressure altitude AG may be used instead of the GPS altitude data when the rate of change in the GPS altitude that is determined exceeds some threshold value, indicating that it has become unreliable. Alternatively, the corrected value of the pressure altitude AG may be used instead of the GPS altitude data when a figure of merit associated with the GPS data falls below a prescribed value. In this way the apparatus may discount the GPS altitude value in instances in which the signals provided by the GPS receiver have become relatively imprecise.

FIG. 2 is an alternative representation of the apparatus shown in FIG. 1. The apparatus includes a GPS receiver 205, a pressure altimeter 210, a noise filter 215, an IRR filter 218, a difference device 220 and summing device 225. The filters 210 and 215, the difference device 220 and the summing device 225 may be embodied in hardware, software or a combination of hardware and software. Moreover, the functionality of any or all of the filters 210 and 215, the difference device 220 and the summing device 22 may be implemented by the processor shown in FIG. 1.

In operation, the GPS receiver 205 determines a GPS altitude value from GPS data obtained from a plurality of GPS satellites. Likewise, the pressure altimeter 210 determines a pressure altitude value. The GPS altitude value is filtered by the noise filter 215 to remove noise. The filtered GPS altitude value and the pressure altitude value are provided to the difference device 220, which determines the altitude difference between the GPS altitude value and the pressure altitude value. The altitude difference is filtered by the IRR filter 218 to obtain a moving average altitude difference. The moving average altitude difference provided by the IIR filter 218 is then summed with the pressure altitude value from the pressure altimeter 210 by the summing device 225 to obtain a corrected pressure altitude.

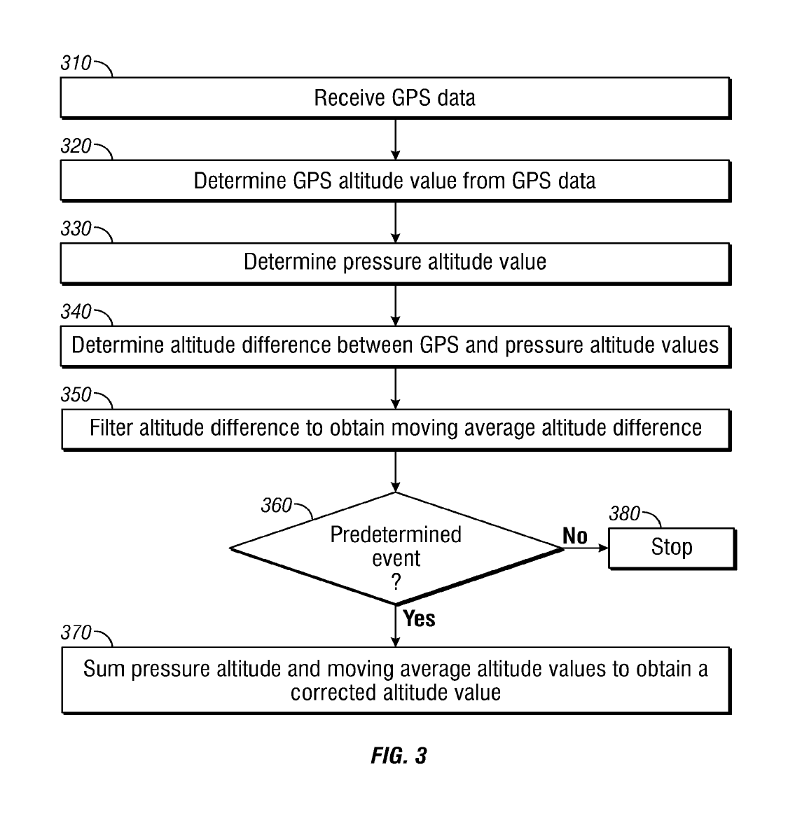

FIG. 3 is a flowchart illustrating one example of method for determining altitude. The method begins at step 310 when GPS data is received from a plurality of GPS satellites. A GPS altitude value is determined from the GPS data at step 320. In addition, a pressure altitude value is determined at step 330. The pressure altitude value and the GPS altitude value may be measured simultaneously or sequentially. In either case, an altitude difference between the GPS altitude value and the pressure altitude value is determined at step 340. The altitude difference is filtered at step 350 to obtain a moving average altitude difference. If at decision step 360 a predetermined event occurs, a corrected altitude value is determined at step 370 by summing the pressure altitude value and the moving average altitude difference. If the predetermined event does not occur, then the process terminates at step 380 and the GPS altitude value is used as the correct altitude value. The predetermined event may arise, for example, when the rate of change in the GPS altitude value exceeds a threshold value or, alternatively, when a figure of merit associated with the GPS data falls below a prescribed value. In some cases the predetermined event may be a combination of both of the aforementioned events.

As noted above, the method for determining altitude described herein may be particularly advantageous when used to determine the altitude of helicopters, which operate relatively low to the ground. Experiments have demonstrated that the process described herein can provide an altitude value that is accurate to within about 10 feet, whereas without this technique the value of the altitude may be only within about 100 feet.

Any of the disclosed methods can be implemented as computer-executable instructions stored on one or more computer-readable storage media (e.g., non-transitory computer-readable media, such as one or more volatile memory components (such as DRAM or SRAM), or nonvolatile memory components (such as hard drives) and executed on a processor. Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, by a processor on a single local computer (e.g., any suitable commercially available computer) or in a network environment (e.g., via the Internet, a wide-area network, a local-area network, a client-server network (such as a cloud computing network), or other such network) using one or more network computers.

Having described and illustrated the principles of our innovations in the detailed description and accompanying drawings, it will be recognized that the various embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of embodiments shown in software may be implemented in hardware and vice versa.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims and their equivalents.

1. A method for determining altitude, comprising:
receiving GPS data from a plurality of GPS satellites;
determining a GPS altitude value from the GPS data;
determining a pressure altitude value;
determining an altitude difference between the GPS altitude value and the pressure altitude value; and
adjusting at least one of the GPS altitude value and the pressure altitude value using the altitude difference.

2. The method of claim 1 wherein adjusting at least one of the GPS altitude value and the pressure altitude value comprises adjusting the pressure altitude value by adding the altitude difference thereto.

3. The method of claim 1 wherein if a rate of change in the GPS altitude value that is determined exceeds a threshold value, determining a corrected altitude by summing the pressure altitude value and the altitude difference.

4. The method of claim 1 wherein further comprising filtering the altitude difference to obtain a moving average altitude difference, wherein adjusting at least one of the GPS altitude value and the pressure altitude value comprises adjusting at least one of the GPS altitude value and the pressure altitude value using the moving average altitude difference.

5. The method of claim 1 wherein filtering the altitude difference comprises filtering the altitude difference with an ER filter or a single-pole filter.

6. The method of claim 1 wherein filtering the altitude difference comprises filtering the altitude difference with an IIR filter having a prescribed time-constant.

7. The method of claim 6 wherein the prescribed time-constant increases with time from startup.

8. The method of claim 7 wherein an increase in the prescribed time-constant terminates after a given amount of time.

9. The method of claim 8 wherein the given amount of time is between about 15 and 30 minutes.

10. The method of claim 1 further comprising filtering the GPS altitude value to remove noise therein.

11. The method of claim 1 wherein further comprising:
receiving a figure of merit associated with GPS data; and
determining a corrected altitude by summing the pressure altitude value and the altitude difference when the figure of merit falls below a prescribed value.

12. A computer-readable storage medium containing instructions which, when executed by one or more processors, implements a method comprising:
obtaining a plurality of GPS altitude values for an aircraft over a period of time;
determining a mean GPS altitude value from the plurality of GPS altitude values;
determining a pressure altitude value;
determining an altitude difference between the mean GPS altitude value and the pressure altitude value;
correcting the pressure altitude value with the altitude difference.

13. An apparatus for determining an altitude of an aircraft, comprising:
a GPS receiver for receiving GPS data from a plurality of GPS satellites and determining a GPS altitude value from the GPS data;
a pressure altimeter for determining a pressure altitude value; and
a processor configured to (i) determine an altitude difference between the GPS altitude value and the pressure altitude value and (ii) adjust at least one of the GPS altitude value and the pressure altitude value using the altitude difference.

14. The apparatus of claim 13 wherein the processor is further configured to adjust the pressure altitude value by adding the altitude difference thereto.

15. The apparatus of claim 13 wherein the processor is further configured to determine a corrected altitude by summing the pressure altitude value and the altitude difference if a rate of change in the GPS altitude that is determined exceeds a threshold value

16. The apparatus of claim 13 further comprising a filter for filtering the altitude difference to obtain a moving average altitude difference, wherein adjusting at least one of the GPS altitude value and the pressure altitude value comprises adjusting at least one of the GPS altitude value and the pressure altitude value using the moving average altitude difference.

17. The apparatus of claim 13 wherein the filter is an IIR filter or a single-pole filter.

18. The apparatus of claim 13 wherein the filter is an IIR filter having a prescribed time-constant.

19. The apparatus of claim 18 wherein the prescribed time-constant increases with time from startup.

20. The apparatus of claim 13 wherein an increase in the prescribed time-constant terminates after a given amount of time from startup.
